(19) United States
(12) Patent Application Publication
(10) Pub. No.: US 2010/0111320 A1
(43) Pub. Date: May 6, 2010

(54) ACOUSTIC SYSTEM AND UPDATE METHOD OF THE ACOUSTIC SYSTEM

(75) Inventor: Tomohide Koike, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/610,483

(22) Filed: Nov. 2, 2009

(30) Foreign Application Priority Data
Nov. 4, 2008 (JP) 2008-282734

(51) Int. Cl. H04B 3/00

(52) U.S. Cl. 381/80

(57) ABSTRACT

There are provided connectors in a main box that selectively outputs an audio signal from source units to zone units and successively updates a program of the zone units by an update data input via the connectors.

### BACKGROUND OF THE INVENTION

1. Field of the Invention

The present invention relates to an acoustic system and an update method of the acoustic system and can be applied to, for example, an acoustic system in which an audio signal is transmitted to each room of a dwelling via a cable deployed in the wall of the dwelling and the audio signal is reproduced by speakers embedded in the wall. The present invention simplifies update processing when compared with processing in related art by providing an update connector in a main box that selectively outputs an audio signal from source units to zone units and successively updating programs of the zone units by update data input via the connector.

2. Description of the Related Art

In related art, acoustic systems in which an audio signal is transmitted to each room of a dwelling via a cable deployed in the wall and the audio signal is reproduced by speakers embedded in the wall have been provided in the USA and other countries. In such an acoustic system, music source equipment is set up in a predetermined location of a dwelling and an audio signal output from the music source equipment is transmitted to each room. The acoustic system has a controller provided in each room to control transmission or the like of the audio signal. Therefore, in such an acoustic system, each piece of equipment constituting a system has a high level of expandability because the system configuration is different from dwelling to dwelling.

Concerning this kind of acoustic system, for example, Japanese Patent Application Laid-Open No. 2000-59408 proposes a method of optimizing resource sharing in a home network.

### SUMMARY OF THE INVENTION

Incidentally, in this kind of acoustic system, it is necessary to update a program of the controller arranged in each room. If, in this case, the controller program is updated in each room, there is a problem that update work will become very complicated.

In light of the foregoing, it is desirable to provide an acoustic system capable of simplifying update processing when compared with a system and an update method of the acoustic system in related art.

According to an embodiment of the present invention, there is provided an acoustic system including a source unit that outputs an audio signal, a plurality of zone units that are each installed in a desired location of a dwelling, output control data in accordance with a user's operation, and output the audio signal from a speaker and a main box that selectively outputs the audio signal of the source unit to the zone units in accordance with the control data. The zone units may output the control data in response to the user's operation by executing a zone unit program maintained in a built-in memory by built-in arithmetic processing means and the main box may update successively the zone unit program of the plurality of zone units by successively transmitting update data input via a connector to the plurality of zone units.

According to an embodiment of the present invention, there is an update method of an acoustic system, comprising, a source unit that outputs an audio signal, a plurality of zone units that are each installed in a desired location of a dwelling, output control data in accordance with a user's operation by executing a zone unit program maintained by built-in arithmetic processing means in a built-in memory, and output the audio signal from a speaker, and a main box that selectively outputs the audio signal of the source unit to the zone units in accordance with the control data, including the step of updating an update target by update data input via a connector. The update step may include the steps of switching the update targets successively by the plurality of zone units and updating the zone unit program to be updated by transmitting the update data to the zone unit to the updated.

According to the embodiment of the present invention, a zone unit program for a plurality of zone units can successively be updated via a main box. Therefore, update processing of each zone unit can be performed in an installation location of the main box without an update being performed in each room so that update processing can significantly be simplified when compared with the past.

According to the present invention, update processing can significantly be simplified when compared with processing in related art concerning an acoustic system in which, for example, an audio signal is transmitted to each room of a dwelling via a cable deployed in the wall of the dwelling and the audio signal is reproduced by speakers embedded in the wall.

### BRIEF DESCRIPTION OF THE DRAWINGS

FIG. 1 is a block diagram showing an acoustic system according to an embodiment of the present invention;

FIG. 2 is a plan view showing a main box in the acoustic system in FIG. 1;

FIG. 3 is a block diagram of the main box in FIG. 2;

FIG. 4 is a plan view of a keypad in the acoustic system in FIG. 1;

FIG. 5 is a block diagram of the keypad in FIG. 3;

FIG. 6 is a flow chart showing a processing procedure in interphone mode;

FIG. 7 is a flow chart showing the processing procedure in door phone mode;

FIG. 8 is a flow chart showing the processing procedure in monitor mode;

FIG. 9 is a flow chart showing the processing procedure in party mode;

FIG. 10 is a block diagram showing connections in update processing; and

FIG. 11 is a flow chart showing the processing procedure in update processing.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### 1. First Embodiment

2. Modification

### FIRST EMBODIMENT

### Configuration of the Embodiment

### [Overall Configuration]

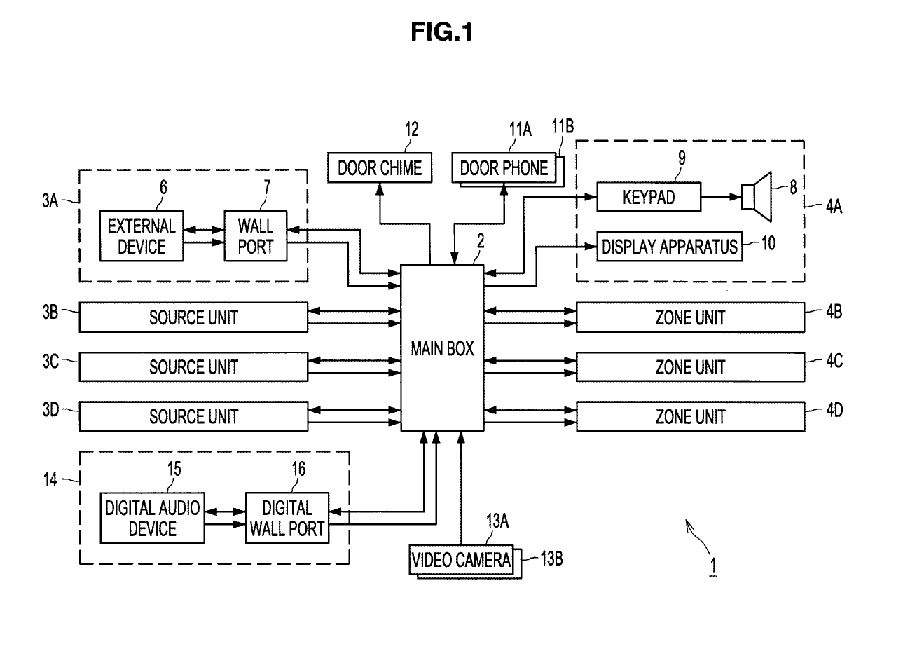

FIG. 1 is a block diagram showing an acoustic system according to a first embodiment of the present invention. An acoustic system 1 transmits an audio signal and a video signal to each room of a dwelling via a cable deployed in the wall and so that the audio signal and video signal are reproduced in each room.

The acoustic system 1 has a main box 2 provided in an inconspicuous location in the basement or the like and source units 3A to 3D provided in an installation location of the main box 2, a listening room or the like. Moreover, each room has zone units 4A to 4D provided therein. Incidentally, the source units 3A to 3D may be provided in the same room as the zone units 4A to 4D. In the acoustic system 1, the source units 3A to 3D and the zone units 4A to 4D are connected to the main box 2 via a cable deployed in the wall. The acoustic system 1 transmits an audio signal and video signal output from the source units 3A to 3D to each of the zone units 4A to 4D via the main box 2 for reproduction.

Here, each of the source units 3A to 3D is a source-side unit that selects content under the control of the main box 2 and outputs an audio signal and video signal of the content to the main box 2. The source units 3A to 3D have an external device 6 that outputs an audio signal or an audio signal and video signal and a wall port 7 forming n interface between the external device 6 and the main box 2 provided therein.

Here, the external device 6 is an audio device or AV device functioning as a dedicated AV receiver or a source. The dedicated AV receiver is a main preamplifier installed in the listening room or the like and has a receiving function of FM broadcasting and TV broadcasting, an external input function, a function of a selector, and an external output function. The dedicated AV receiver switches operations and outputs an audio signal and video signal to the wall port 7 based on control data transmitted from the main box 2 via the wall port 7. The dedicated AV receiver also selects an video signal and audio signal input into an external input terminal to output the video signal and audio signal to the wall port 7 by controlling an external device connected to the external input terminal.

Therefore, if the dedicated AV receiver is applied to the external device 6, the acoustic system 1 is configured in such a way that a desired audio device or AV device can be added using the external input terminal of the dedicated AV receiver. Further, by directly inputting a video signal and audio signal of the external device 6 of another source unit into the external input terminal of the AV receiver, the external device 6 of the other source unit can be used in the listening room or the like. On the other hand, an audio device functioning as a source is, for example, a compact disk player, tuner of FM broadcasting and the like. An AV device functioning as a source is, for example, a tuner of TV broadcasting and the like.

The wall port 7 is an input/output terminal installed on the wall. The wall port 7 outputs control data output from the main box 2 to the external device 6 and outputs an audio signal and video signal output from the external device 6 to the main box 2.

The zone units 4A to 4D are terminal units installed in a room or the like. The zone units 4A to 4D output control data to the main box 2 in response to a user's operation and reproduces an audio signal or a voice signal transmitted from the main box 2. The zone units 4A to 4D have a keypad 9 that outputs control data to an external speaker 8 embedded in the wall and the main box 2 and also drives the external speaker 8 based on an audio signal output from the main box 2 and a display apparatus 10 that reproduces a video signal output from the main box 2 provided therein. The display apparatus 10 is installed as necessary.

The main box 2 switches operations to control operations of each of the source units 3A to 3D based on control data output from the zone units 4A to 4D. The main box 2 selectively outputs an audio signal and video signal input from each unit by the operation switching to the zone units 4A to 4D.

More specifically, the main box 2 selects an audio signal and video signal output from the desired source units 3A to 3D to output the audio signal and video signal to the zone units 4A to 4D under the control of the keypad 9 provided in each of the zone units 4A to 4D and also outputs control data to the external device 6 provided in each of the source units 3A to 3D. As a result, in the acoustic system 1, the source and content can be selected by operating the keypad 9 in each room to enjoy the selected content in each room.

[Configuration Concerning Extensions]

The keypad 9 switches the operation mode to an interphone mode based on a user's operation. The interphone mode is an operation mode in which the keypad 9 is used as a terminal apparatus of an interphone to transmit and receive a voice signal between the keypads 9. The keypad 9 transmits a voice signal acquired by a built-in microphone to the main box 2. The main box 2 transmits the voice signal to the other zone units 4A to 4D and, after an audio signal being silenced, the zone units 4A to 4D output the transmitted voice signal from an internal speaker. Conversely, the other zone units 4A to 4D acquire a voice signal and transmit the voice signal to the zone units 4A to 4D via the main box 2. Accordingly, in the acoustic system 1, a call can be made between rooms in which the zone units 4A to 4D are installed by using each of the zone units 4A to 4D as an interphone terminal.

Further, door phones 11A and 11B can be connected to the main box 2 and if an operation control to call the door phone 11A or 11B is operated, a ring tone is output by driving a door chime 12. The main box 2 also outputs a voice signal output from the door phone 11A or 11B to the corresponding zone units 4A to 4D under the control of the zone units 4A to 4D and transmits a voice signal acquired by the zone units 4A to 4D to the door phone 11A or 11B for output. The corresponding zone units 4A to 4D silence an audio signal and then output the transmitted voice signal from an internal speaker or output a voice signal acquired by a microphone to the main box 2. Accordingly, in the acoustic system 1, a conversation can be held with a visitor from each room in which the zone units 4A to 4D are installed by using each of the corresponding zone units 4A to 4D as a terminal of the door phone 11A or 11B.

The main box 2 has a monitor video signal from video cameras 13A and 13B input thereinto and outputs the monitor video signal to the desired zone units 4A to 4D under the control of the keypad 9. Accordingly, the acoustic system 1 can monitor, for example, pets or visitors in the entranceway from each room in which the zone units 4A to 4D are installed.

A digital source unit 14 is a source-side unit that uses a digital audio device 15 such as a mobile music player as a music source. The digital source unit 14 outputs control data output from the main box 2 to the digital audio device 15 via a digital wall port 16. The digital source unit 14 also outputs a digital audio signal output from the digital audio device 15 to the main box 2 via the digital wall port 16. The main box 2 outputs control data, like the source units 3A to 3D, also to the digital source unit 14 and has a digital audio signal input thereinto to selectively output the digital audio signal to the zone units 4A to 4D. Accordingly, in the acoustic system 1, music content accumulated in a mobile music player or the like can also be enjoyed in each room in which the zone units 4A to 4D are installed.

[Detailed Configuration of the Main Box]

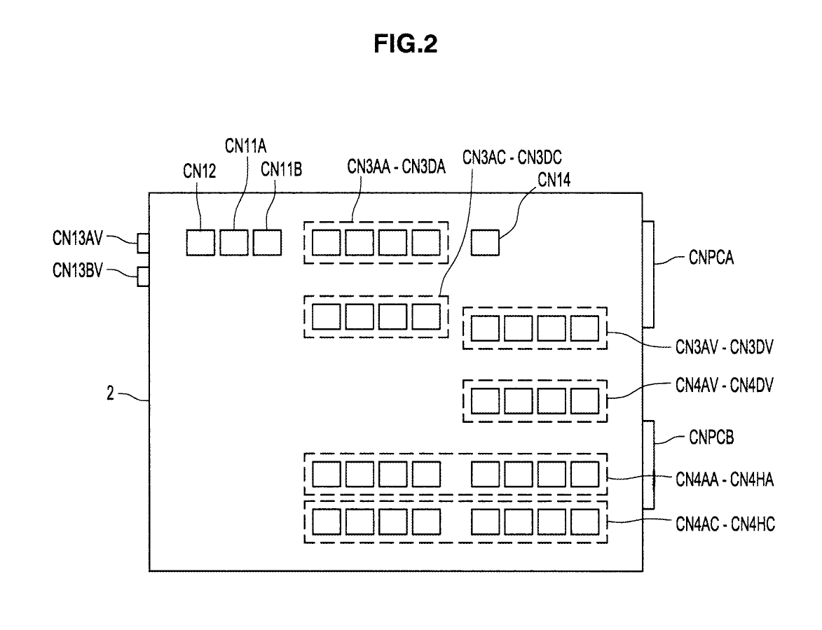

FIG. 2 is a plan view showing an external configuration of the main box 2. The main box 2 is created in a box-like shape and connectors CN11A, CN11B, CN12, and CH14 to connect the door phones 11A and 11B, the door chime 12, and the digital source unit 14 respectively are provided on a top surface thereof. Connectors CN3AA to CN3DA, CN3AC to CN3DC, and CN3AV to CN3DV for audio signal, data communication, and video signal to connect the source units 3A to 3D respectively are provided on the top surface. Also, connectors CN4AA to CN4HA, CN4AC to CN4HC, and CN4AV to CN4DV for audio signal, data communication, and video signal to connect the zone units 4A to 4D respectively are provided on the top surface.

Incidentally, the connectors CN4AA to CN4HA and CN4AC to CN4HC for audio signal and data communication to connect the zone units 4A to 4D respectively are provided for eight systems. In contrast, the connectors CN4AV to CN4DV for video signal to connect the zone units 4A to 4D respectively are provided for four systems. Therefore, while the main box 2 can connect up to eight zone units, four systems thereof are terminals that reproduce only an audio signal without the display apparatus 10 being installed.

The main box 2 has connectors CN13AV and CN13BV to input a monitor video signal and CNPCA and CNPCB to connect a computer provided on the side thereof.

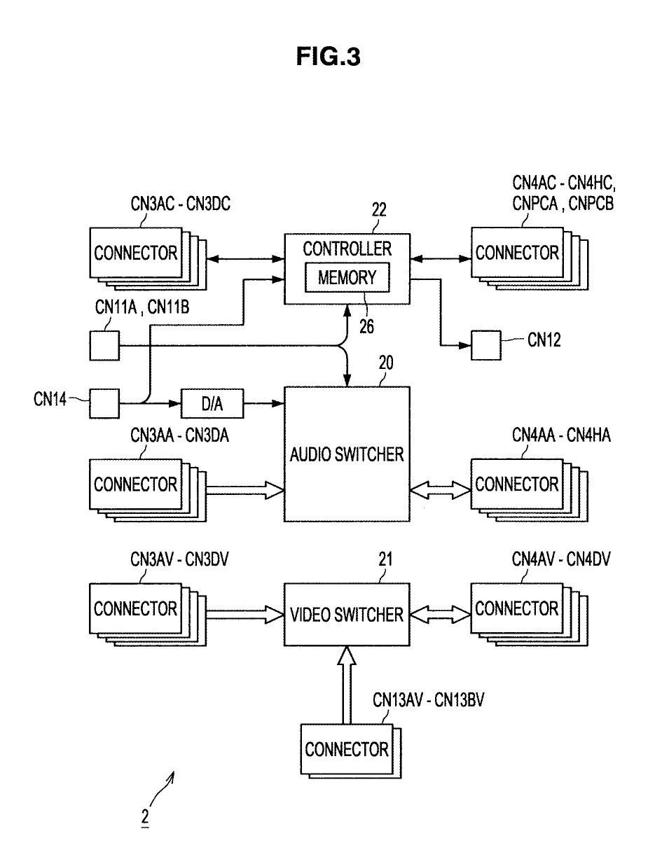

FIG. 3 is a block diagram showing a detailed configuration of the main box 2. In the main box 2, a video switcher 21 is a switcher to switch output of a video signal. The video switcher 21 has a video signal of the source units 3A to 3D input thereinto via the connectors CN3AV to CN3DV and a monitor video signal from the video cameras 13A and 13B input thereinto via the connectors CN13AV and CN13BV. The video switcher 21 selectively outputs the input video signal or monitor video signal to the zone units 4A to 4D via the connectors CN4AV to CN4DV under the control of a controller 22.

An audio switcher 20 is a switcher to switch output of an audio signal and voice signal. The audio switcher 20 has an audio signal of the source units 3A to 3D input thereinto via the connectors CN3AA to CN3DA. The audio switcher 20 selectively outputs the input audio signal to the zone units 4A to 4D via the connectors CN4AA to CN4HA under the control of a controller 22.

The audio switcher 20 has a voice signal input thereinto from the door phone 11A or 11B via the connector CN11A or CN11B and a voice signal input thereinto from the zone units 4A to 4D via the connectors CN4AA to CN4HA. The audio switcher 20 selectively outputs the voice signal from the door phone 11A or 11B to the zone units 4A to 4D via the connectors CN4AA to CN4HA under the control of a controller 22. The audio switcher 20 also selectively outputs the voice signal from the zone units 4A to 4D to the door phone 11A or 11B via the connector CN11A or CN11B and to the other zone units 4A to 4D via the connectors CN4AA to CN4HA. The audio switcher 20 also has a digital audio signal from the digital source unit 14 input via a connector CN14 input thereinto after being converted into an analog signal by a digital/analog conversion circuit 25. The audio switcher 20 selectively outputs the audio signal input from the digital/analog conversion circuit 25 to the zone units 4A to 4D via the connectors CN4AA to CN4HA under the control of the controller 22.

The controller 22 is arithmetic processing means for controlling operations of the acoustic system 1 and controlling operations of each unit of the acoustic system 1 by executing a program recorded in a memory 26. Thus, the controller 22 is connected to the source units 3A to 3D and the zone units 4A to 4D via the connectors CN3AC to CN3DC and CN4AC to CN4HC for data communication respectively and also is connected to the door phones 11A and 11B via the connectors CN11A and CN11B respectively in such a way that an operation by the calling operation control can be detected. The controller 22 is also connected to the door chime 12 via the connector CN14 in such a way that the door chime 12 can be controlled.

[Detailed Configuration of the Keypad]

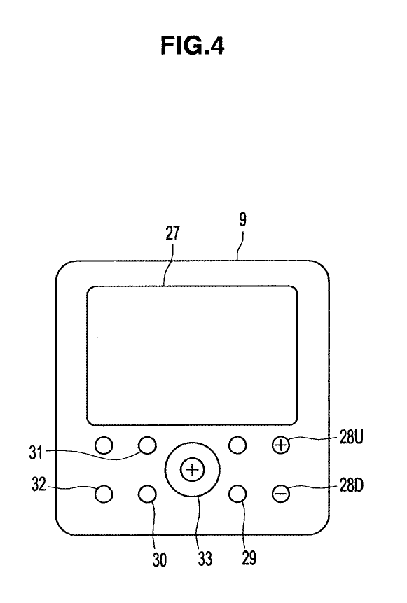

FIG. 4 is a plan view showing the external configuration of the keypad 9. The keypad 9 has a rectangular shape protruding from a back surface thereof and is installed on the wall of each room by embedding the protruding portion in the wall. The keypad 9 has a display unit 27 to display a menu screen and the like and also volume operation controls 28U and 28D, a silencing operation control 29, a menu display operation control 30, an execution/return operation control 31, a power operation control 32, a cursor/input operation control 33 and the like provided thereon.

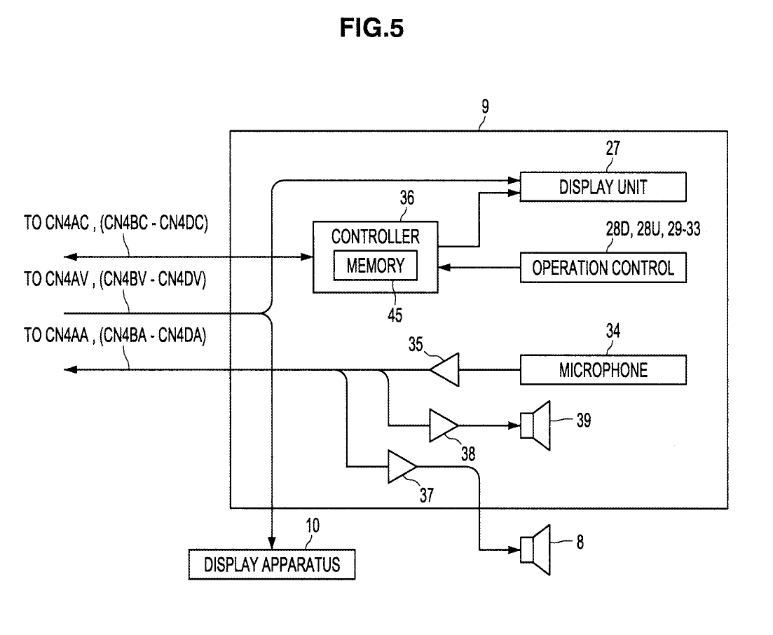

FIG. 5 is a block diagram showing the keypad 9. The keypad 9 acquires a voice signal of the user through a built-in microphone 34 and amplifies the voice signal by an amplification circuit 35. The keypad 9 outputs the voice signal output from the amplification circuit 35 to the main box 2 under the control of a controller 36. The keypad 9 also drives the external speaker 8 by an amplification circuit 37 based on an audio signal transmitted from the main box 2. The keypad 9 also drives a built-in speaker 39 by an amplification circuit 38 based on an audio signal transmitted from the main box 2.

In the keypad 9, the controller 36 is arithmetic processing means for controlling operations of the acoustic system 1 together with the controller 22 of the main box 2. The controller 36 controls operations of each unit of the acoustic system 1 by executing a program recorded in a memory 45. The keypad 9 has a receiving unit that receives a remote control signal from a remote commander and is configured in such a way that each unit can be controlled by operating a remote controller in the same manner as when the operations controls 28D to 33 are operated.

[Control of the Controllers 22, 36]

In the acoustic system 1, if the power operation control 32, the menu display operation control 30, or a corresponding operation control of the remote commander is operated, the controller 36 of the keypad 9 displays a main menu screen in the display unit 27 based on an instruction of the controller 22 of the main box 2. The controller 36 displays the current time detected by a built-in timer in the display unit 27 in the standby state. The controller 36 switches the display of the display unit 27 by starting up the power supply of the keypad 9 when the power operation control 32 or the corresponding operation control of the remote commander is operated. If the power supply of the main box 2 is not up and running when the power supply of the keypad 9 is started up, control data is output to the controller 22 of the main box 2 to start up the power supply of the main box 2 as well.

In the main menu screen, the controller 36 accepts a menu selection by an operation of the cursor/input operation control 33 or the corresponding operation control of the remote commander. A lower-level menu screen is displayed according to an instruction of the controller 22 by a menu selection to further accept a menu selection. Accordingly, the acoustic system 1 accepts a menu selection by displaying a menu in a hierarchical structure.

Here, the controllers 22, 36 accept setup settings by the menu selection and record setup information in the memory 26 of the controller 36. The setup is, for example, settings of icons constituting the menu of each of the source units 3A to 3D and names thereof, settings of the names of rooms in which the zone units 4A to 4D are set up, settings of icons constituting the menu of the door phones 11A and 11B and names thereof, and associations of the video cameras 13A and 13B with the zone units 4A to 4D or the door phones 11A and 11B. More specifically, the names of the source units 3A to 3D are, for example, FM broadcasting, AM broadcasting, TV broadcasting and the like and the names of rooms in which the zone units 4A to 4D are set up are, for example, a living room, kitchen and the like. Names of the door phones 11A and 11B are, for example, an entrance and the like. If, for example, the video camera 13A is installed in a room in which the zone unit 4A is installed, associations of the video cameras 13A and 13B are settings of a link between the video camera 13A and the zone unit 4A.

The controller 22 provides instructions of the display of the main menu screen, lower-level menu screens and the like to the controller 36 based on setup information recorded in the memory 26 and the controller 36 displays the main menu screen, lower-level menu screens and the like using icons and names set by setup based on the notification to accept various kinds of selections.

[Control of the Source Unit]

Here, if the selection of a menu of the source units 3A to 3D is made in the main menu screen, the controller 36 notifies the controller 22 of the main box 2 of the selection. The controller 22 performs data communication with the external device 6 of the corresponding source unit 3A to 3D based on the notification to detect content selectable by the external device 6. The controller 22 notifies the controller 36 of the detected selectable content and the controller 36 displays a lower-level menu screen by displaying a menu of selectable content based on the notification. When a menu of content is selected, the controller 22 is notified of the selection.

The controller 22 of the main box 2 controls the corresponding source units 3A to 3D, the audio switcher 20, and the video switcher 21 based on the notification to input an audio signal and video signal concerning the user-selected content and selectively outputs the audio signal and video signal to the corresponding zone units 4A to 4D.

The controller 36 of the keypad 9 outputs an audio signal output from the main box 2 from the external speaker 8 under the control of the amplification circuit 37 and starts up the power supply of the display apparatus 10 to reproduce a video signal in the display apparatus 10.

The controller 36 also controls the amplification circuit 37 to perform processing of variable volume, silencing or cancellation of silencing by operating the volume operation controls 28U and 28D or the silencing operation control 29 in a state in which music content or video content being reproduced.

Similarly, the controller 36 accepts source and content selections by switching the display of the display unit 27 by operating the cursor/input operation control 33 and provides instructions to the main box 2 to switch to the selected source and content. The controller 22 of the main box 2 switches operations of the corresponding zone units 4A to 4D, the video switcher 21, and the audio switcher 20 following instructions from the controller 36 to input an audio signal and video signal concerning the user-reselected source and content before outputting the audio signal and video signal to the corresponding zone units 4A to 4D.

In the acoustic system 1, desired music content or video content can be used in each room in which the zone units 4A to 4D are installed by a sequence of control operations by the controllers 22, 36.

If a dedicated AV receiver is connected to the external device 6, an external device is connected to the external input terminal of the AV receiver, and a source unit of the AV receiver is selected in the main menu screen, the controller 36 displays a lower-level menu screen by displaying a menu to select the external device connected to the AV receiver. After the selection of the external device in the lower-level menu screen, a menu of content selectable by the corresponding external device is displayed. Information necessary for the display of these lower-level menus and content menus is acquired by the controller 22 of the main box 2 from an external device by, for example, data communication via the AV receiver. The menu display of the external device may be set by the setup.

[Interphone Mode]

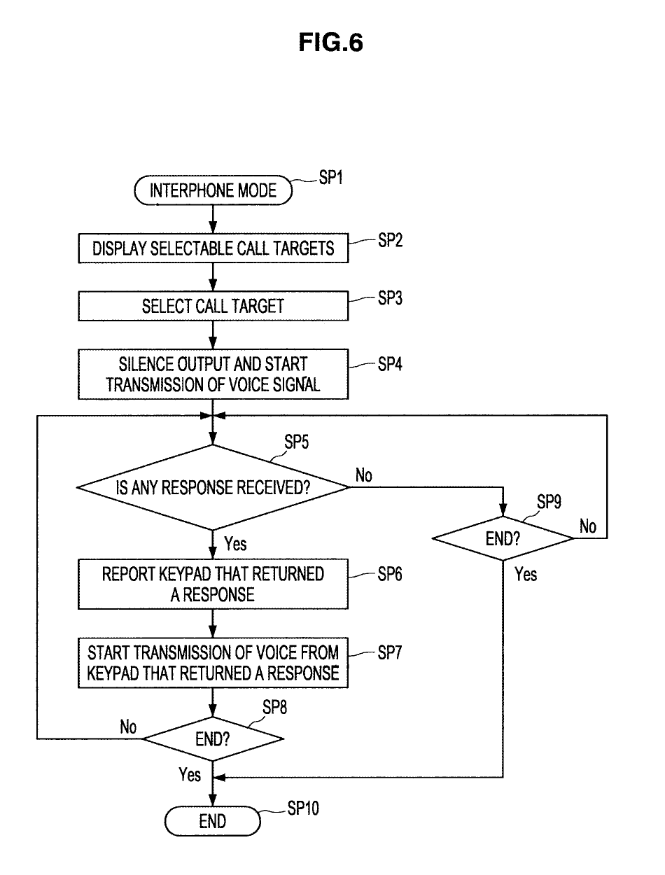

FIG. 6 is a flow chart showing a processing procedure for the controllers 22, 36 in interphone mode. If a menu of the interphone mode is selected in the main menu screen, the controller 22 switches the operation mode to the interphone mode to start the processing procedure and moves from step SP1 to step SP2. A zone unit in which the interphone mode is set will be called a calling-side zone unit below.

At step SP2, the controller 22 notifies the controller 36 of the keypad 9 of the interphone mode and the controller 22 notifies the controller 36 of selectable call targets based on records in the memory 26 by this notification. Here, selectable call targets all other zone units or one zone unit. The controller 36 lists selectable call targets by the name of rooms set by the setup based on the notification from the controller 22 of the main box 2.

Subsequently, the controller 22 moves to step SP3, the selection of a call target from the listing by the user is accepted, and the controller 22 of the main box 2 is notified of the selected call target. The controller 22 of the main box 2 notifies the call target keypad 9 of the name of the room in which the calling-side zone unit is installed by this notification and the name of the calling-side room is displayed by the call target display unit 27. In this case, if the power supply of the call target keypad 9 is not up and running, the controller 22 starts up the power supply of the keypad 9 before notification of the name of the room.

At subsequent step SP4, the calling-side controller 22 silences output of an audio signal from the external speaker 8 and starts output of a voice signal acquired by the microphone 34 to the main box 2. If no audio signal has been output from the external speaker 8, silencing processing is omitted. The controller 22 of the main box 2 controls the operation of the audio switcher 20 corresponding to processing of the controller 36 at step SP4 to output a voice signal output from the calling-side keypad 9 to the call target keypad 9. The call target keypad 9 silences output of an audio signal from the external speaker 8 and outputs a voice signal transmitted from the main box 2 from the built-in speaker 39. Also in this case, if no audio signal has been output from the external speaker 8, silencing processing is omitted.

At subsequent step SP5, the controller 22 of the main box 2 determines whether a response has been received from the call target keypad 9. Here, the controller 36 of the call target keypad 9 starts output of the voice signal from the built-in speaker 39. If a predetermined operation control is operated in this state, the call target controller 22 notifies the main box 2 of the response and also stops output of the voice signal from the built-in speaker 39 and outputs the voice signal acquired by the microphone 34 to the main box 2. Therefore, if a predetermined operation control is operated in the call target keypad 9, the controller 22 of the main box 2 gets a positive result and at step SP5 and moves from step SP5 to step SP6.

At step SP6, the controller 22 of the main box 2 notifies the calling-side controller 36 of the response and the calling-side controller 36 displays the name of the room of the zone unit that returned a response by the notification in the display unit 27. At subsequent step SP7, the controller 22 controls the operation of the audio switcher 20 and transmits a voice signal from the keypad 9 that returned a response to the calling side.

Subsequently, the controllers 22, 36 move to step SP8 and determines whether the end of the interphone mode is instructed by determining whether the execution/return operation control 31 is operated in the calling-side keypad 9. If a negative result is obtained at step SP8, the controllers 22, 36 return to step SP5. On the other hand, if a negative result is obtained at step SP5, the controllers 22, 36 move to step SP9 and, like step SP8, determines whether the end of the interphone mode is instructed. If a negative result is obtained here, the controllers 22, 36 return to step SP5. On the other hand, if the execution/return operation control 31 is operated in the calling-side keypad 9, the controllers 22, 36 move to step SP10 to end the processing procedure because a positive result will be obtained at step SP8 or SP9. With the end of the processing procedure, the calling-side controller 36 and the call target controller 36 return to original operation modes thereof to end output of the voice signal and silencing of the audio signal.

Accordingly, in the acoustic system 1, a voice signal acquired by a calling-side keypad is transmitted to a call target and also a voice signal acquired by a call target keypad is transmitted to the calling side to configure the terminal of an interphone by each zone unit.

[Door Phone Mode]

When an operation of the calling operation control of the door phone 11A or 11B is detected, the controller 22 of the main box 2 switches the operation mode to the door phone mode. Here, the door phone mode is an operation mode that causes the keypad 9 to function as the terminal of the door phone 11A or 11B. If the power supply of the main box 2 is not up and running, the controller 22 starts up the power supply and then switches the operation mode to the door phone mode.

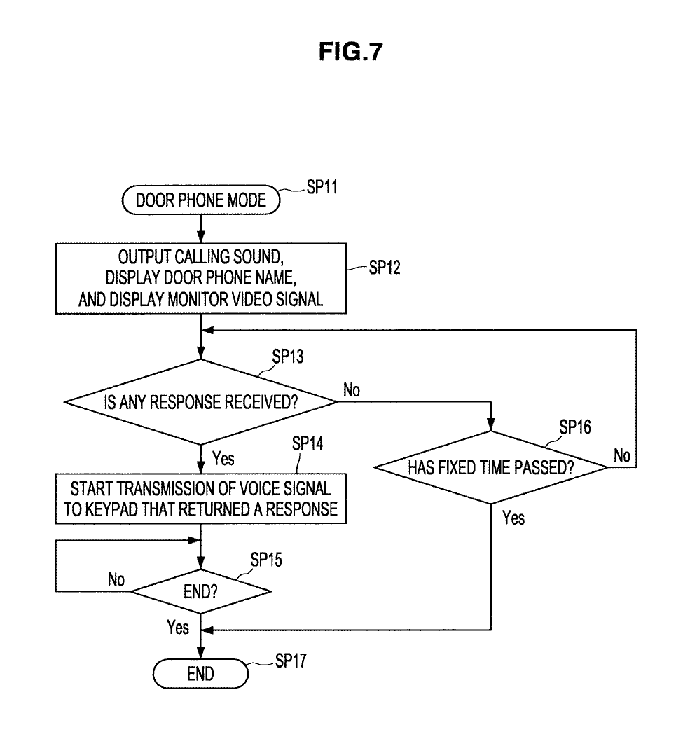

FIG. 7 is a flow chart showing the processing procedure for the controllers 22, 36 in door phone mode. When the processing procedure is started, the controller 22 of the main box 2 moves from step SP11 to step SP12 to output a calling sound. Here, if the door chime 12 is connected and the door phone 11A or 11B and the door chime 12 are associated by setup processing, the controller 22 outputs a calling sound by driving the door chime 12. On the other hand, if the door chime 12 is not connected or the door phone 11A or 11B and the door chime 12 are not associated, the controller 36 controls the zone units 4A to 4D to output a calling sound from the built-in speaker 39.

Further, the controller 36 notifies the zone units 4A to 4D of the name of the corresponding door phone 11A or 11B set in the setup and displays the name in the display unit 27. Further, if the video camera 13A or 13B and the door phone 11A or 11B are associated in the setup, a monitor video signal of the corresponding video camera 13A or 13B is output to the zone units 4A to 4D and displayed in the display unit 27 under the control of the video switcher 21. Accordingly, the acoustic system 1 can check the figure of a visitor from each room set in advance.

Subsequently, the controller 22 moves to step SP13 to determine whether a response is received from any zone unit. Here, if a predetermined operation control is operated, the controller 36 of the keypad 9 notifies the main box 2 of the response and also silences output of an audio signal before starting output of a voice signal acquired by the microphone 34 to the main box 2. Based on the response from the controller 36, the controller 22 of the main box 2 obtains a positive result at step SP13 and moves from step SP13 to step SP14.

At step SP14, the controller 22 starts transmission/reception of a voice signal between the door phone 11A or 11B and the zone unit that returned a response under the control of the audio switcher 20. That is, the controller 22 starts output of the voice signal of the door phone 11A or 11B to the zone unit that returned a response and output of the voice signal of the zone unit that returned a response to the door phone 11A or 11B.

Subsequently, the controller 22 moves to step SP15 to determine whether the end of the door phone mode is instructed by determining whether the execution/return operation control 31 of the keypad that returned a response is operated. If a negative result is obtained at step SP15, the controller 22 repeats step SP15. If a negative result is obtained at step SP13, the controller 22 moves to step SP16 to determine whether a fixed time has passed and, if a negative result is obtained here, returns to step SP13. On the other hand, if a positive result is obtained at step SP15 or SP16, the controller 22 moves to step SP17 to end the processing procedure. With the end of the processing procedure, the keypad 9 that returned a response returns to the original operation thereof to end output of the voice signal and silencing of the audio signal.

Accordingly, in the acoustic system 1, a voice is exchanged with the door phone 11A or 11B by using the keypad 9 installed in each room as a terminal apparatus of the door phone 11A or 11B.

[Control of the Controllers 22, 36 in Monitor Mode]

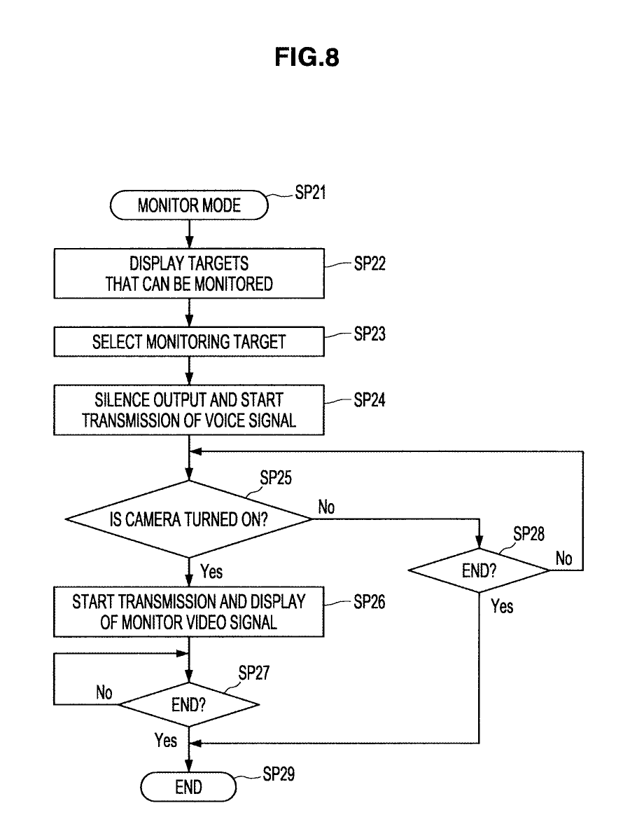

FIG. 8 is a flow chart showing the processing procedure of the controllers 22, 36 in monitor mode. Here, the monitor mode is an operation mode in which one of the rooms in which the zone units 4A to 4D are installed as a monitoring target and audio of the monitoring target or audio and video of the monitoring target are monitored by other zone units. If the menu of the monitor mode is selected in the main menu screen, the controller 36 of the keypad 9 switches the operation mode to the monitor mode to start the processing procedure and moves from step SP21 to step SP22.

At step SP22, the controller 36 of the keypad 9 lists targets that can be monitored based on records in the memory 26 by means of data communication with the controller 22. Here, the controller 36 lists targets that can be monitored by listing the names of rooms in which the other zone units are installed based on a notification from the controller 22.

Subsequently, at step SP23, the controller 36 accepts the selection of a monitoring target by making a selection from the listing and notifies the controller 22 of the main box 2 of the selection. If an audio signal has been reproduced by the external speaker 8, output of the audio signal is silenced.

Based on the notification from the controller 36, at subsequent step SP24, the controller 22 of the main box 2 instructs the keypad 9 of the monitoring target to switch the operation and silences output of an audio signal by the keypad 9. Further, the controller 22 makes settings so that a voice signal acquired by the microphone 34 is output to the main box 2 by controlling the amplification circuit 38 in the keypad 9. The controller 22 also controls the audio switcher 20 to output the voice signal output from the keypad 9 to be monitored to the keypad 9 in monitor mode before the voice signal is output from the built-in speaker 39. Accordingly, the acoustic system 1 starts voice monitoring of another room by the keypad 9 in monitor mode.

Here, in processing of the setup, if the zone unit to be monitored and the video camera 13A or 13B are associated, the controller 22 notifies the keypad 9 in monitor mode of the association. When monitoring of a voice signal starts in the keypad 9 in monitor mode, the controller 36 displays a menu of video monitoring in the display unit 27 based on the notification. When the selection of the menu of video monitoring is detected, the controller 22 of the main box 2 is notified of the selection.

The controller 22 of the main box 2 determines whether the notification is present at step SP25 and, if a positive result is obtained here, moves to step SP26. Here, the controller 22 outputs a corresponding monitor video signal to the keypad 9 in monitor mode by controlling the video switcher 21 and in the keypad 9, the monitor video signal is displayed in the display unit 27 under the control of the controller 36. Accordingly, the acoustic system 1 starts voice monitoring of another room by the keypad 9 in monitor mode.

Subsequently, the controller 22 moves to step SP27 to determine whether the end of the monitor mode is instructed by determining whether the execution/return operation control 31 of the keypad 9 in monitor mode is operated. If a negative result is obtained at step SP27, the controller 22 moves to step SP28 to repeat step SP27. If a negative result is obtained at step SP25, like step SP27, the controller 22 determines whether the end of the monitor mode is instructed and, if a negative result is obtained here, returns to step SP25. On the other hand, if a positive result is obtained at step SP27 or SP28, the controller 22 moves to step SP29 to end the processing procedure. With the end of the processing procedure, the keypad to be monitored and that in monitor mode return to the original operations thereof to end output of the voice signal and silencing of the audio signal.

[Control of the Digital Source Unit]

If the menu of the digital source unit 14 is focused in the main menu screen, the controller 22 of the main box 2 performs data communication with the digital audio device 15 via the digital wall port 16 to acquire attribute information of the digital audio device 15. The controller 22 detects the device name of the digital audio device 15 based on the attribute information and displays the device name in the main menu screen by notifying the corresponding keypad 9 of the device name. The device name here is, for example, a mobile music player, mobile phone with a reproduction function of music and the like and the controller 22 displays these device names using the names set in the setup.

When the selection of a device name is notified by the controller 36, the controller 22 detects selectable menus in the digital audio device 15 based on similar data communication with the digital audio device 15. The controller 22 notifies the corresponding keypad 9 of the detected menus and the controller 36 of the keypad 9 displays the detected menus in a lower-level menu screen based on the notification. Selectable menus here are for a mobile music player, for example, a play list, artist, album, genre, piece and the like.

When the selection of a menu is notified from the controller 36 in the lower-level menu screen, the controller 22 detects selectable menus based on similar data communication with the digital audio device 15 and notifies the controller 36 of the selectable menus and also displays the selectable menus.

Accordingly, the controller 36 accepts the selection of content through the same user interface as that when the digital audio device 15 is directly operated and controls the operation of each unit so that the selected content is output to the corresponding zone unit.

[Party Mode]

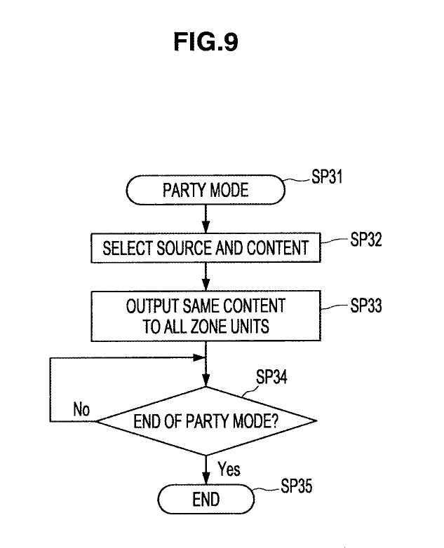

FIG. 9 is a flow chart showing the processing procedure for the controllers 22, 36 in party mode. Here, the party mode is an operation mode in which the same content from the same source is reproduced by all zone units. If a menu of the party mode is selected in the main menu screen, the controller 36 of the keypad 9 switches the operation mode to the party mode to start the processing procedure and moves from step SP31 to step SP32.

Here, the controller 36 notifies the main box 2 of the switching of the operation mode to the party mode. The controller 36 also displays a menu screen similar to that described above to accept the selection of a source and content from the user and notifies the main box 2 of the selection of the source and content.

At subsequent step SP33, the controller 22 of the main box 2 outputs an audio signal and video signal by the source and content notified at step SP32 to all zone units under the control of the video switcher 21 and the audio switcher 20. The controllers 36 of all zone units correspondingly reproduce the audio signal and video signal output from the main box. If, in this case, the power supply of the keypad 9 is not up and running, the controller 36 starts up the power supply thereof before reproducing the audio signal and video signal. Accordingly, in the acoustic system 1, content selected by one zone unit is reproduced in all zone units. The controller 22 accepts an operation to switch the source or content from all zone units.

Subsequently, the controller 22 of the main box 2 determines whether the end of the party mode is instructed by determining whether the execution/return operation control 31 is operated in any zone unit. If a negative result is obtained at step SP34, the controller 22 repeats step SP34. On the other hand, if a positive result is obtained at step SP34, the controller 22 moves to step SP35 to end the processing procedure and to restore settings of each unit to states before starting the party mode.

[Update Processing]

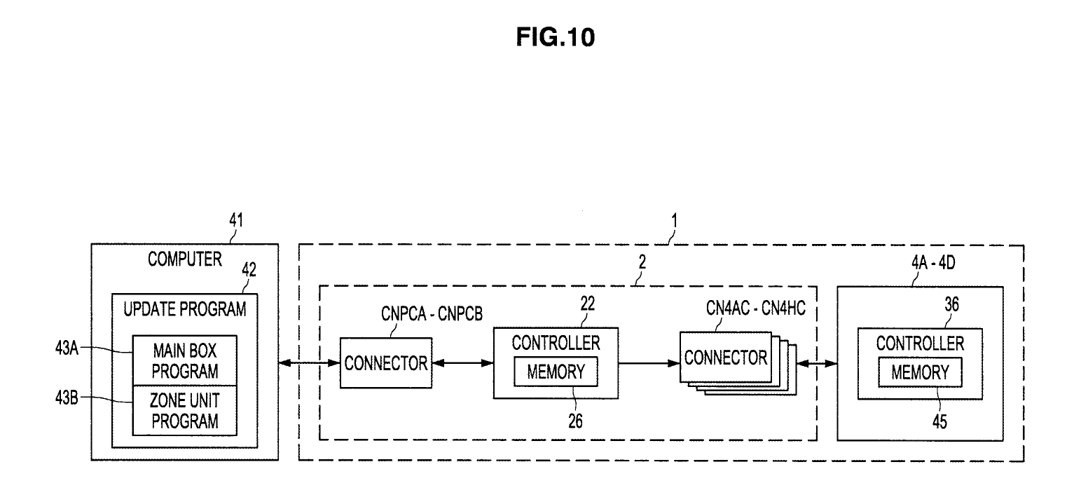

FIG. 10 is a block diagram offered to illustrate update processing. The acoustic system 1 executes an update program 42 on a computer 41 connected to the main box 2 to update programs recorded in the memory 26 of the main box 2 and the memory 45 of each of the zone units 4A to 4D by a main box program 43A and a zone unit program 43B maintained in the update program 42 respectively.

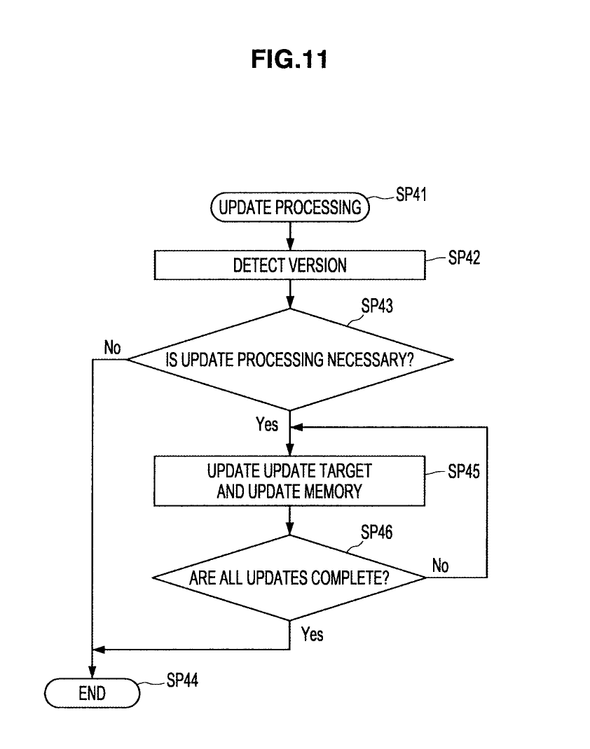

FIG. 11 is a flow chart showing the processing procedure for the computer 41 by the update program. When execution of the update program is instructed, the computer 41 moves from step SP41 to step SP42. At step SP42, the computer 41 detects the version of the program maintained in the memory 26 of the controller 22 through data communication with the controller 22 of the main box 2. The computer 41 also detects the version of the program maintained in the memory 45 of the controller 36 through data communication with the controller 36 of each of the keypads 9 via the controller 22.

Subsequently, the computer 41 moves to step SP43. Here, the computer 41 judges each version detected at step SP42 based on versions of the programs 43A, 43B maintained in the update program to detect the main box 2 and the keypad 9 that need an update. The computer 41 determines whether it is necessary to perform an update based on a detection result and, if a negative result is obtained here, the computer 41 moves from step SP43 to step SP44 to end the processing procedure.

On the other hand, if there is the main box 2 or the keypad 9 that needs an update, a positive result is obtained at step SP43 and the computer 41 moves from step SP43 to step SP45. Here, the computer 41 sets one of the main box 2 and the keypad 9 that need an update as an update target. The maintained program 43A or 43B is transmitted to the update target to update records of the memory 26, 45 by the transmitted program 43A or 43B.

Subsequently, the computer 41 moves to step SP46 to determine whether all the main box 2 and the keypad 9 that need an update are updated. If a positive result is obtained here, the computer 41 moves to step SP44 to end the processing procedure. On the other hand, if a negative result is obtained at step SP46, the computer 41 returns to step SP45 by switching the update target.

Accordingly, in the acoustic system 1, programs in the main box 2 and the keypad 9 are successively updated by the computer 41 connected to the main box 2.

### Operations of the Embodiment

In the above configuration of the acoustic system 1 (FIGS. 1 to 5), if a source and content are selected in the keypad 9 provided in one of the zone units 4A to 4D, the main box 2 is notified of the selection. Each unit is controlled by the controller 22 provided in the main box 2 based on the notification and a video signal and audio signal of the user-selected content are selectively output to the corresponding zone units 4A to 4D via the video switcher 21 and the audio switcher 20. The video signal and audio signal output from the main box 2 are transmitted through a cable deployed in the wall to each of the zone units 4A to 4D and reproduced by the display apparatus 10 and the speaker 8.

Accordingly, in the acoustic system 1, a lease is shared by rooms and desired content can be enjoyed in each room by operating the keypad 9 installed in each room. When an audio device or video device installed in a listening room or the like is applied to the external device 6 of the source units 3A to 3D, music content or video content viewed in a listening room or the like can be enjoyed in each room.

In the acoustic system 1, a dedicated AV receiver having the receiving function of FM broadcasting and TV broadcasting, external input function, function of a selector, and external output function and controllable by the main box 2 is prepared as An audio device installed in the listening room. Therefore, when the dedicated AV receiver is applied to the external device 6, various sources can be added by using the external input terminal of the of the AV receiver and accordingly, expandability of the acoustic system can be further extended. In this case, because sources can be added without a source unit being added, sources can be added without doing large-scale work such as deployment of cables in the wall of a dwelling so that the system configuration of this type of the acoustic system 1 can be changed flexibly and easily.

Moreover, the digital source unit 14 can be connected to the main box 2 in the acoustic system 1 and if the digital source unit 14 is selected in the keypad 9 provided in one of the zone units 4A to 4D, the main box 2 is notified of the selection. Each unit is controlled by the controller 22 provided in the main box 2 based on the notification and the menu of the digital audio device 15 provided digital source unit 14 is displayed to accept the selection of content. The digital audio device 15 is controlled by the main box 2 based on the selection and an audio signal output from the digital audio device 15 is transmitted to the corresponding zone units 4A to 4D for reproduction. Accordingly, in the acoustic system 1, by using the digital audio device 15 such as a mobile music player as a source, music content of the digital audio device 15 can be enjoyed in each room.

In the acoustic system 1, the main box 2 is configured in such a way that a monitor video signal can be input into the main box 2 and in the case of the door phone mode or monitor mode, the monitor video signal is selectively output to the zone units 4A to 4D according to user's instructions detected via the keypad 9. In each of the zone units 4A to 4D, the monitor video signal is displayed in the display unit 27 of the keypad 9. Accordingly, in the acoustic system 1, the monitor video signal can also be monitored in rooms in which the zone units 4A to 4D are installed by making effective use of the configuration in which a video signal and audio signal are output to each of the zone units 4A to 4D. Therefore, in the acoustic system 1, a video camera that outputs a monitor video signal may be installed when necessary to use the video camera for various kinds of monitoring or the like, enabling extension of the range of availability by further expanding functions.

More specifically, the main box 2 is configured in such a way that the door phones 11A and 11B can be connected and a calling sound is output from the door chime 12 or the zone units 4A to 4D by operating the calling operation control in door phone mode in the door phone 11A or 11B. If the user operates one of the zone units 4A to 4D and a response is received, a voice signal is exchanged between the zone unit 4A to 4D from which a response is received and the door phones 11A and 11B. Accordingly, in the acoustic system 1, a visitor can be dealt with by voice by using the keypad 9 provided in the zone units 4A to 4D as a terminal apparatus of door phone.

If the door phone 11A or 11B and the video camera 13A or 13B are associated in setup processing in advance in the acoustic system 1, a monitor video signal from the video camera 13A or 13B is output to the corresponding zone unit 4A to 4D and displayed according to instructions of the user in processing in door phone mode. Accordingly, in the acoustic system 1, the video camera 13A or 13B may be installed, for example, in an entrance hall to be able to check the figure of a visitor by the video camera 13A or 13B, enabling function extension when compared with the past.

In monitor mode, on the other hand, a monitoring target is set by operating one of the zone units 4A to 4D and a zone unit operated by the user is set as a transmission target. A voice signal of the zone units 4A to 4D set as a monitoring target is acquired in monitor mode and the voice signal is transmitted to the transmission target via the main box 2. In the transmission target, the voice signal is output from the built-in speaker 8. Accordingly, in the acoustic system 1, for example, conditions of a room in which another zone unit is installed are monitored based on voice to monitor conditions of the room.

If the zone unit 4A to 4D set as a monitoring target in setup processing in advance and the video camera 13A or 13B are associated in the acoustic system 1, a monitor video signal from the video camera 13A or 13B is output to the corresponding zone unit 4A to 4D and displayed according to instructions of the user in monitor mode. Accordingly, in the acoustic system 1, conditions of a room in which another zone unit may be installed are monitored based on video, in addition to voice, to monitor conditions of the room, enabling extension of the range of availability by further expanding functions.

Particularly, by setting output of a monitor video signal in door phone mode or monitor mode by associations in setup processing, the range of availability can be extended by flexibly dealing with the installation location of a video camera that changes in various ways depending on the system configuration. That is, visitors can be checked by installing two units of the video cameras 13A and 13B, for example, in the entrance and the back door together with the door phones 11A and 11B respectively or instead, visitors and pets can be monitored by installing the video cameras 13A and 13B in the entrance and the living room respectively. Or, pets can be monitored by arranging two units of the video cameras 13A and 13B in the living room and a pet room.

In the acoustic system 1, on the other hand, if the user selects the interphone mode in one of the zone units 4A to 4D, the zone unit is set as the calling side and the selection of the call target zone unit 4A to 4D is accepted. A voice signal acquired by the microphone 34 contained in the keypad 9 is exchanged between the calling side and the call target side via the main box 2 in the acoustic system 1. Accordingly, in the acoustic system 1, the keypad 9 of each of the zone units 4A to 4D can be used as a terminal apparatus of interphone, thereby enabling extension of the range of usage.

On the other hand, if the user selects the party mode in one of the zone units 4A to 4D, a video signal and audio signal of the source and content selected in the zone unit 4A to 4D are output to all the zone units 4A to 4D from the main box 2. Accordingly, in the acoustic system 1, for example, when a party is given in a dwelling, music content and video content common to all rooms can be provided, further improving ease of use when compared with the past.

Also in party mode, if switching of the source and content is instructed in the zone units 4A to 4D including the zone units that selected the party mode, the video signal and audio signal output to all the zone units 4A to 4D by the main box 2 are switched according to the instruction. Accordingly, in the acoustic system 1, in a party, for example, content can be changed in various ways by operating the nearby zone unit 4A to 4D while music content and video content common to all rooms being provided, further improving ease of use.

Incidentally, each unit of the acoustic system 1 is controlled by executing programs stored in the memories 26, 45 of the main box 2 and the keypad 9 by the controllers 22, 36 respectively. Therefore, it becomes necessary to update programs stored in these memories 26, 45. However, since the keypad 9 is installed in each room, if no new way is devised, it will be necessary to move to each room in which the keypad 9 is installed to update the keypad 9 separately. Therefore, update processing will be very complicated.

Particularly in this type of the acoustic system 1, programs may be updated when a long time passes after installation and in such a case, even the location of the keypad 9 may be unknown. Thus, in such a case, it becomes difficult to update a portion of the keypads 9 constituting the acoustic system in the end. Therefore, it becomes difficult to reliably update the acoustic system 1 as a whole.

Thus, in the acoustic system 1 (FIGS. 10 and 11), the main box 2 is provided with the connectors CNPCA and CNPCB to connect a computer and a computer is connected to the connector CNPCA or CNPCB. Using the computer, the keypads 9 are successively updated by transmitting update data to the keypads 9 via the main box 2 and the main box 2 is also updated. Accordingly, in the acoustic system 1, the keypads installed in each room can successively be updated from the location where the main box 2 is installed, simplifying update processing significantly when compared with the past.

Moreover, even the keypad 9 whose location is unknown can also be updated reliably by transmitting update data by using the data communication cable to transmit control data from the keypad 9.

### Effect of the Embodiment

According to the above configuration, update processing can be simplified when compared with the past by providing connectors in a main box that selectively outputs an audio signal from source units to zone units and updating programs in the main box successively by update data input via the connectors.

By transmitting the update data to a plurality of zone units via a data communication cable deployed in a wall to input control data from the zone units at this point, update processing can be simplified by effectively using the existing configuration and further, update processing can reliably be performed even if a long period of time passes after installation.

Also by performing update processing of the main box, the update processing can be simplified when compared with the past.

<Modification>

It should be understood by those skilled in the art that various modifications, combinations, sub-combinations and alterations may occur depending on design requirements and other factors insofar as they are within the scope of the appended claims or the equivalents thereof.

In the embodiment described above, a case in which a computer is connected and zones units are successively updated by executing a program in the computer is described. However, the present invention is not limited to such an example and, for example, update data may be provided by recording the update data in a memory card so that zone units may be successively updated with the update data by executing a program provided in a main box.

In the above embodiment, a case in which the present invention is applied to an acoustic system that transmits an audio signal and vide signal. However, the present invention is not limited to such an example and can also be applied widely to an acoustic system that transmits only an audio signal.

The present invention can be applied to an acoustic system that transmits an audio signal to each room of a dwelling via a cable deployed in the wall of the dwelling and reproduces the audio signal by a speaker embedded in the wall.

The present application contains subject matter related to that disclosed in Japanese Priority Patent Application JP 2008-282734 filed in the Japan Patent Office on 4 Nov. 2008, the entire content of which is hereby incorporated by reference.

What is claimed is:

1. An acoustic system, comprising:
a source unit that outputs an audio signal;
a plurality of zone units that are each installed in a desired location of a dwelling, output control data in accordance with a user's operation, and output the audio signal from a speaker; and
a main box that selectively outputs the audio signal of the source unit to the zone units in accordance with the control data, wherein
the zone units
output the control data in response to the user's operation by executing a zone unit program maintained in a built-in memory by built-in arithmetic processing means and
the main box
updates successively the zone unit program of the plurality of zone units by successively transmitting update data input via a connector to the plurality of zone units.

2. The acoustic system according to claim 1, wherein
the main box
has the control data via a data communication cable deployed in a wall of the dwelling input thereinto and
transmits the update data to the plurality of zone units via the data communication cable.

3. An update method of an acoustic system, comprising:
a source unit that outputs an audio signal;
a plurality of zone units that are each installed in a desired location of a dwelling, output control data in accordance with a user's operation by executing a zone unit program maintained by built-in arithmetic processing means in a built-in memory, and output the audio signal from a speaker; and
a main box that selectively outputs the audio signal of the source unit to the zone units in accordance with the control data, including the step of:
updating an update target by update data input via a connector, wherein
the update step includes the steps of:
switching the update targets successively by the plurality of zone units; and
updating the zone unit program to be updated by transmitting the update data to the zone unit to the updated.

4. The update method of an acoustic system according to claim 3, wherein
the main box
selectively outputs the audio signal in accordance with the control data by executing a main box program maintained by built-in arithmetic processing means in a built-in memory and
the update step, further comprising the step of:
updating the main box program by the update data.
